(19) United States
(12) Patent Application Publication
(10) Pub. No.: US 2016/0048644 A1
(43) Pub. Date: Feb. 18, 2016

(54) HEALTH CARE EXPERIENCE DATA MANAGEMENT

(71) Applicants: Nicholas G. Anderson, Knoxville, TN (US); David F. Williams, Minnetonka, MN (US); John S. Pollack, Naperville, IL (US)

(72) Inventors: Nicholas G. Anderson, Knoxville, TN (US); David F. Williams, Minnetonka, MN (US); John S. Pollack, Naperville, IL (US)

(21) Appl. No.: 14/723,507

(22) Filed: May 28, 2015

Related U.S. Application Data
(60) Provisional application No. 62/038,221, filed on Aug. 16, 2014.

(51) Int. Cl. G06F 19/00

(52) U.S. Cl. CPC G06F 19/327

(57) ABSTRACT

An apparatus that includes an input portal for receiving data including pointers for identifying health care providers and performance data correlated to the pointers. A first analyzer analyzes the performance data to identify categories of related performance data. A compiler compiles the data into compiled data that includes a plurality of the pointers and categories of data associated with the pointers. A second analyzer analyzes the categories of data and scores the data within each category to produce an outcome score for each category of data, where each outcome score is associated with a pointer. An access portal provides access to the data to health care providers, and provides health care provider-selectable display criteria to the health care providers using the access portal, and records a display criteria selected by each health care provider. A selection portal provides access to the data to users, and presents choice criteria to users using the selection portal, and receives and stores the choice criteria from users. The choice criteria includes at least a subset of the health care provider information. An information manager displays information to a user based upon the compiled data including the categories of data and the pointers, the outcome scores, the pointers, the display criteria and the choice criteria.

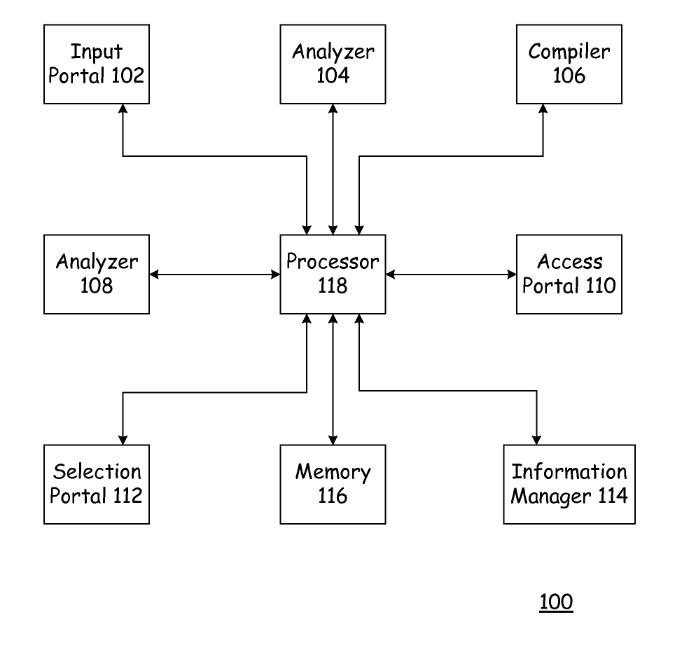

### FIELD

This invention relates to the field of health care. More particularly, this invention relates to the management of data related to the amount of experience a health care provider has in various services, including procedures and diagnoses, as well as outcomes for various services.

### INTRODUCTION

Their health and well-being is, for most people, a primary concern. For this reason, people like to investigate the background of a prospective health care provider, prior to engaging his services or following his prescribed course of treatment. Unfortunately, the vast majority of information available on doctors is anecdotal. Web sites have been erected on which third parties, whether they have been a patient of the health care provider or not, can post their personal opinion about the health care provider. Often these opinions are posted anonymously and the public has no way of knowing if the opinion is real, and the health care provider has no way to correct the posting, or in some situations, even respond.

What is needed, therefore, is a system for the management of health care provider experience data that reduces problems such as those described above, at least in part.

### SUMMARY

The above and other needs are met by an apparatus that includes an input portal for receiving data including pointers for identifying health care providers and performance data correlated to the pointers. A first analyzer analyzes the performance data to identify categories of related performance data. A compiler compiles the data into compiled data that includes a plurality of the pointers and categories of data associated with the pointers. A second analyzer analyzes the categories of data and scores the data within each category to produce an outcome score for each category of data, where each outcome score is associated with a pointer. An access portal provides access to the data to health care providers, and provides health care provider-selectable display criteria to the health care providers who are using the access portal, and records a display criteria selected by each health care provider. A selection portal provides access to the data to users, and presents choice criteria to users using the selection portal, and receives and stores the choice criteria from users. The choice criteria includes at least a subset of the health care provider information. An information manager displays information to a user based upon the compiled data including the categories of data and the pointers, the outcome scores, the pointers, the display criteria and the choice criteria.

According to another aspect of the invention there is described a processor-based method for administering a database of health care provider information. The health care provider information is compiled, and includes at one of least health care provider identifier, health care provider location information, health care provider specialty, health care provider type, and health care provider service information, where the health care provider service information includes at least one of services performed as indicated by service code, service outcome rate by service code, number of services performed by service code.

Access to the database is provided to health care providers that have associated health care provider information in the database. Health care provider-selectable user display criteria is provided to the health care providers that have access to the database, and the user display criteria selected by the health care providers recording in the database. Health care provider selection criteria are received from users, where the health care provider selection criteria includes at least a subset of the health care provider information.

Additional portions of the health care provider information associated with the health care provider selection criteria are presented to the users, which matches the health care provider-selectable user display criteria, where services having related service codes are combined into a single display category.

In various embodiments according to this aspect of the invention, the health care provider location information includes at least address, city, state, and zip code. In some embodiments the health care provider-selectable user display criteria includes at least minimum number of services performed, maximum number of services performed, and minimum outcome for services performed. In some embodiments the additional portions of the health care provider information presented to the users is presented as summarized data within predetermined binned categories instead of actual data. In some embodiments information on health care providers other than those selected by the users is displayed for comparison purposes. In some embodiments the information displayed on the selected health care providers is sortable by user-selectable criteria, including at least number of combined services and outcomes of combined services. In some embodiments outcome rate is expressed as a percentage. In some embodiments the outcome rate is expressed as a value in a binned category. In some embodiments the number of services is expressed as a number. In some embodiments the number of services is expressed as a value in a binned category.

According to another aspects of the invention, there is described a non-transitory computer-readable medium containing computer-readable instructions for instructing a computer to enable and perform the methods described herein.

### DRAWINGS

Further advantages of the invention are apparent by reference to the detailed description when considered in conjunction with the FIGURE, which is not to scale so as to more clearly show the details, and which depicts a functional block diagram for an apparatus according to an embodiment of the invention.

### DESCRIPTION

With reference now to the FIGURE, there is depicted an apparatus 100 according to an embodiment of the present invention. Data is input through an input portal 102. The data in one embodiment relates to information in regard to a selection of health care providers. As used herein, the term health care provider includes physicians, psychologists, dentists, chiropractors, optometrists, nurse practitioners, assistants, nurses, and other health care professionals, practices, or businesses in related fields, as well as hospitals, ambulatory surgical centers, laboratories, diagnostic centers, treatment centers, and other related health care facilities.

For example, the data might include the number of different services offered by a health care provider (where services is defined to include at least one of procedures and diagnoses), what those services are, how many of each service the health care provider has performed, the outcome of each service, the number of patients seen for various services, personal information such as age, years in practice, address, and so forth.

The data can also include a service code, such as at least one of the Current Procedural Terminology (CPT) codes, the Health Care Common Procedure Coding System (HCPCS) codes, the International Classification of Disease (ICD) codes, the Systematized Nomenclature of Medicine-Clinical Terms (SNOMED CT) code, and some other service code. Data can be obtained from the health care providers themselves, health care provider EHRs, practice management systems, health information exchanges, registries, claims data, exchange data, health care payers, public records, and so forth.

The data can also include an identifier, such as at least one of the name of the health care provider, National Provider Identifier, and other alphanumeric identifier. Data in some embodiments includes health care provider specialty. Data can also include health care provider type, such as physician, hospital, or ambulatory surgery center.

Data in some embodiments includes the following:

Utilization data, which is defined as the number of procedures performed (such as by CPT code) or patients seen (such as by ICD code) in given timeframe. Utilization can be reported as an actual, exact number of procedures or patients, a range of procedures or services, or a score (such as numerical, stars, etc.) based on a comparison of that health care provider's actual numbers to those of other health care providers, such as locally or nationally.

Outcome data, which for certain services would be reported as actual outcomes, such as Visual Acuity following cataract surgery. Outcome can also be reported as average outcome (such as 20/25 for all cataract surgeries), percentage of services whose outcome falls within specified ranges (such as 80% are 20/25 to 20/20, 10% are 20/30 to 20/25, 10% are worse than 20/30), or a score (such as numerical, stars, etc.) based on a comparison of that health care provider's actual outcomes to those of other health care providers, such as locally or nationally.

Complication data, which for certain services would be reported as complication rates (such as endophthalmitis following cataract surgery, infection after total knee replacement, death after CABG). Complication can also be reported as the percentage of services with any complication, or the percentage of services with a specific complication (such as infection versus death), or a score (such as numerical, stars, etc.) based on a comparison of that health care provider's complication rates to other health care providers, such as locally or nationally.

The health care providers for which data is included can be selected according to one or more of a variety of different criteria. For example, health care provider data can be selected for inclusion in the database based upon criteria such as the practice type of the health care provider or the location of the health care provider.

A processor 118 receives the data that is input through the input portal 102, and stores the data in a memory 116. The data is stored with pointers that correlate data points in regard to a given health care provider as an associated set of data. The data in regard to a health care provider can be edited, such as by adding new data to the existing data on some regular basis, such as on a quarterly or yearly basis, so as to add data in regard to the services that the health care provider has performed during the prior period of time, or to record any location or demographic changes, and so forth. In addition, data that might be erroneous can be removed or corrected at any time.

A first analyzer 104 analyzes the data to identify categories of related performance data. In one embodiment the analyzer 104 identifies categories of data by grouping related services. For example, glaucoma surgery is covered by at least twelve different CPT codes. To a layperson, however, many of these twelve different services have no practical distinction, but are instead—to the layperson—all the same general thing. The analyzer 104 identifies such related services and thereby identifies groups or categories of related services that are expected to be of interest to the data users, and provides the grouped category identifications to the processor 118, which stores the grouped category identifications in the memory 116. Each grouped category identified by the analyzer 104, therefore, includes a generic designation for an included set of more specific services, and may include a lookup table associating lay descriptions of services or diagnoses to technical/clinical descriptors.

A compiler 106 receives the data, including the category identifications, and compiles the raw data as received from the input portal 102 into compiled data sets that include the pointers that associate the raw data with a given health care provider and the category identifications.

A second analyzer 108 analyzes the categories of data, and scores the data with each category to produce an outcome score for each category of data. These outcome scores are also associated with a relevant pointer for the data. The outcome score can take a number of different forms. In one embodiment, the outcome score is a raw percentage of the number of services that are designated as successful, where success is defined differently in different embodiments. Some embodiments display actual outcomes, such as average visual acuity following cataract surgery, and some display complication rates. In another embodiment the outcome score is a number of tokens, such as stars, on a given scale of tokens, such as five, that groups the number of services into a bin represented by a given number of tokens on the scale. For example, a doctor with a given outcome in a given category of services might receive four out of five stars as an outcome score.

In some embodiments a given service or grouped category of services does not have a characterization such as successful versus unsuccessful. In such cases, the outcome score can be a statistical value based upon a more relevant measure for the services.

In some embodiments the number of services in a given category is computed by totaling the number of all of the separate services that have been grouped together in the category by the first analyzer 104. For example, even though the raw data might indicate that a given health care provider has one hundred services in each of five different iridectomy services, the total number of services for the category is taken as the sum of all of those services, which is five hundred.

By further example, a given health care provider may have performed 1,200 cataract surgeries with CPT code 66982 and 800 cataract surgeries with CPT code 66984. In one embodiment the display for “cataract surgery” for that health care provider would show 2,000 cases.

The number of successful services for that category is also determined by summing the number of successes for each of the individual services in the category. So, if the health care provider had 9 successful services in each of the five different iridectomy sub categories, then the number of successful services in the grouped category of iridectomy services would be forty-five.

An access portal 110 provides access to the system 100 to those health care providers whose data is stored in the memory 116. Through the access portal 110, the system 100 provides display criteria to a health care provider who is logged into the system 100. By setting the display criteria as desired, the health care provider is able to control how his data is subsequently used and presented by the system 100. The display criteria can include, for example, criteria that enables the health care provider to prevent the subsequent presentation of data that is below a given rate, as indicated by the outcome score. The display criteria can also include, for example, criteria that enables the health care provider to prevent the subsequent display of data that is represented by a number of grouped services that is below a given threshold. The display criteria includes, in some embodiments, criteria that enables the health care provider to categorically prevent the presentation of all data in regard to a given grouped category.

In some embodiments the display criteria are set for the database as constituted at the time of setting the criteria. In other embodiments, the criteria are continually applied against the dataset as it exists after updates, and when criteria are met, the associated action is taken in regard to presentation of the data. For example, rather than just turning off the presentation of data through the setting of the display criteria, a health care provider can adjust the display criteria through the access portal 110 such that if his data ever in the future meets a given threshold, then the display formatting associated with the criteria will apply, so as selectively permitting or denying the presentation of the relevant data. In some embodiments, the criteria are independently set for individual services or grouped categories of services, and in some embodiments the criteria are globally implemented for a given health care provider across all of his reported services in the dataset.

In some embodiments there are display criteria that are applied to the number of services performed, either for individual services or for categories of services. For example, in some embodiments the total number of services performed will not display, but instead, the total number of services will be indicated as being either greater than or lower than a specified value, such as greater than 1,000, or less than 100. In other embodiments the total number of services—again, either for a single service or for a category of services—can be specified for display via the display criteria as being within a given range, such as 100-200, 200-300, 300-400, and so forth.

In some embodiments the health care provider can specify, through use of the display criteria and the access portal 110, that his performance data will be displayed in comparison to the performance data for other health care providers that offer the same services as those selected for display. In some embodiments, the display of performance data for this selection of health care providers can be displaying in a ranked format, such as by the total number of services (such as from greatest to least) or by the outcome score (again, such as from highest to lowest).

In some embodiments, the access portal 110, through the use of the display criteria, enables the health care provider to verify that their data is accurate, and control what data is shown. In this manner, the data presented for display is verified as being accurate (such as by the health care provider), and some means can be used to certify to the user of the system that receives the displayed data that the data is accurate. For example, after setting the display criteria and checking his data, a health care provider can press a system button that indicates that the data is accurate. The system 100 then presents a certificate when the data is displayed, certifying to the user that the data is accurate.

In some embodiments the system analyzes the user input and places targeted advertisements on the page that is displayed. In some embodiments the health care providers pay to have their office advertisement or web site link show up on the page that is displayed, such as when they are included in a search, or otherwise, such as when health care providers in their specialty or procedures they perform or diagnoses they manage are displayed.

The system 100 has a selection portal 112 that enables potential patients or other interested parted to access, select, and view the data according to a number of different choice criteria. In some embodiments the choice criteria includes data such as the performance (such as number of services, services themselves, outcomes (either by individual service or grouped category of services)), provider type (physician, hospital, surgery center), name of provider, or geographic location.

The information manager 114 receives the choice criteria from the user through the selection portal 112 presents relative portions of the data based at least in part on the choice criteria, the display criteria. The information manager uses the pointers that are associated with the various elements of the data set to select the relevant data for each health care provider to be displayed, uses the display criteria to either format or exclude the data for display as determined by the health care provider, and presents the data to the user through the selection portal 112.

In some embodiments the system 100 is implemented in customized hardware with modules having the functions as described above. In other embodiments the system 100 is implemented in a general purpose computer, such as a PC. In other embodiments, the system 100 is implemented across multiple computing platforms that are interconnected, such as by either by dedicated communication buses or global networks, such as the Internet.

In one embodiment according to a method of the present invention, the following steps are performed. (a) A patient chooses a service from a drop-down menu, such as “gallbladder removal.” (b) By choosing “gallbladder surgery,” the system searches for all CPT codes for gallbladder removal, such as 47562, 47563, 47564, 47600, 47605, 47610, 47612, and 47620. In other words, the portal takes a lay term for a service and uses that input to search for and select multiple CPT codes by using a reference table or other system. (c) The patient chooses a ZIP code in which to search for health care providers. (d) The system displays all physicians in that ZIP code and surrounding ZIP codes who have data for services in the database that match with any of the selected CPT codes.

(e) Because the data might not include all of the services performed by a health care provider, a score of from 1-5 stars is displayed, where the stars are based on, for example, percentile of number of services performed. If the data indicates that Surgeon A did more gall bladder surgeries than 90% of all of the other surgeons displayed, then he or she would be scored a 5-star surgeon. If Surgeon B did more gall bladder surgeries than 50% of all of the other surgeons displayed, then he or she would be scored a 3-star surgeon. The scores could also be based on all health care providers in a different pool, rather than just those displayed. For example, the scores could be based on a state-wide or national basis. (f) The patient can also input the name of a specific health care provider and the system displays the scores for all of the services that the health care provider performs, based on CPT entries.

Some embodiments include scoring systems in which health care providers are compared to each other. In some embodiments the scores (such as stars) are based on achieving thresholds of utilization or outcomes. With one embodiment of threshold scoring, if it takes 900 surgeries to get four stars, then a surgeon with 1,000 surgeries would get four stars regardless of what his or her comparison group did.

In some embodiments the scoring is normalized using different databases of health care provider utilization or outcomes. For example, a Medicare utilization database can be used in some embodiments to provide health care provider data. However, some health care providers don't see Medicare patients at all, so if this were the only database used, it would look like some surgeons didn't do any surgeries at all, when in fact they might do many surgeries on patients with private insurance. So, some embodiments score health care providers relative to or within individual databases.

For example, when using the Medicare data database, health care providers are scored based on either their comparison group of health care providers within that database or thresholds within that database. The Medicare database might indicate that Surgeon X did 2000 surgeries on Medicare patients in 2014, while the average surgeon in the Medicare database did 1000 surgeries. Surgeon X is awarded four stars based on either comparison against the average or a threshold within that specific database. Surgeon Y doesn't take Medicare and therefore has zero surgeries in this database and therefore gets zero stars.

However, if a Blue Cross data database is used, and a health care providers score is based on either their comparison group of health care providers within that database or thresholds within that database. Surgeon X does not take Blue Cross and has zero surgeries in this database and therefore now gets zero stars. Surgeon Y does take Blue Cross and did 3000 surgeries on Blue Cross patients in 2014. The average surgeon in the Blue Cross database did 1500 surgeries. Surgeon Y is now awarded four stars based on either comparison against the average or a threshold within that specific database.

In other embodiments, for each health care provider the system displays either an average of rankings for each database, or the highest ranking of all the databases. In this manner, the scores from different databases are normalized.

In some embodiments, data is obtained directly from at least one of health care provider billing systems and electronic health record systems, such as through either an automated interface or by the provider manually uploading the data. In some embodiments, one data source can be compared and normalized against other data bases. In one embodiment the system separates out all of the Medicare encounters for a given health care provider obtained from the health care provider-sourced data, and compares them against a database from Medicare itself. In another embodiment the system separates out all of the Blue Cross encounters for a given health care provider obtained from the health care provider-sourced data, and compares them against a database from Blue Cross itself.

If a health care provider provides their data directly, their data in some embodiments is indicated to the public as verified, or with some other descriptor to denote that the data came directly from the health care provider rather than a third party source. Such designations can provide an incentive for the health care providers to upload their data to the system.

One major source of data is claims data. When a patient sees a health care provider, the health care provider files a claim with the patient's insurance company. The insurance company then sells the claims data to data brokers. Thus, most visits by a patient to a health care provider generate a claim, the data for which is bought and sold. Usually, however, not all of the data is available. More typically about 30% of the claims for a given health care provider are available. The data broker typically provides their estimation of the percentage of penetrance of claims from a given health care provider. So, claims data might only provide 300 of a health care provider's 1000 surgeries for a given year, for example.

In one embodiment the raw number of procedures or encounters from claims data is divided by the penetrance estimate to produce an estimate of the total number of procedures. That estimate is then used to score the health care provider. So, for example, if Surgeon A's claims data shows 1000 procedures for 2014 and the data broker estimates they have 50% of his claims (50% penetrance), the system in one embodiment would estimate that Surgeon A did 2000 total surgeries, and that would be the number that is used for his scoring or other display.

When a user searches for a given procedure or diagnostic, they will typically use layman's terms (such as “eye surgery” for cataract surgery), and the system will present options for such in some embodiments. In one embodiment all the terms patients enter into the search field are collected, collated, and assigned to the relevant ICD9 or CPT codes or SNOMED CT codes, or HCPCS codes, or other procedural or diagnostic other codes, which are then used to populate the results of the search as previously described, thereby correlating layman's terms to CPT or ICD9 codes or SNOMED CT or HCPCS or other procedural or diagnostic codes.

Some embodiments include a reference table that correlates user-entered search terms to procedure or diagnosis descriptors. For example, if a patient searches for “eye surgery,” the system can display a message such as “Did you mean” and a drop down list including (for example) “cataract surgery,” “vitrectomy,” and “blepharoplasty.” In this manner, a broad search term like “eye surgery” can be used to identify a more specific search term like “cataract surgery,” and then that term can be used as an entry to the reference table, which correlates “cataract surgery” with the multiple CPT codes or SNOMED CT codes or HCPCS codes or other procedural codes for “cataract surgery.”

The present system according various embodiments gives patients and other users the ability to set criteria for their health care provider search, such as by the number of services performed, the range of services performed, and outcome for those services.

The foregoing description of embodiments for this invention has been presented for purposes of illustration and description. It is not intended to be exhaustive or to limit the invention to the precise form disclosed. Obvious modifications or variations are possible in light of the above teachings. The embodiments are chosen and described in an effort to provide illustrations of the principles of the invention and its practical application, and to thereby enable one of ordinary skill in the art to utilize the invention in various embodiments and with various modifications as are suited to the particular use contemplated. All such modifications and variations are within the scope of the invention as determined by the appended claims when interpreted in accordance with the breadth to which they are fairly, legally, and equitably entitled.

1. An apparatus comprising:
an input portal for receiving data including pointers for identifying health care providers and performance data correlated to the pointers,
a first analyzer for analyzing the performance data to identify categories of related performance data,
a compiler for compiling the data into compiled data that includes a plurality of the pointers and categories of data associated with the pointers,
a second analyzer for analyzing the categories of data and scoring the data within each category to produce an outcome score for each category of data, each outcome score being associated with a pointer,
an access portal for providing access to the data to health care providers, for providing health care provider-selectable display criteria to the health care providers using the access portal, and for recording a display criteria selected by each health care provider,
a selection portal for providing access to the data to users, for presenting choice criteria to users using the selection portal, for receiving and storing the choice criteria from users, where the choice criteria includes at least a subset of the health care provider information, and
an information manager for displaying information to a user based upon the compiled data including the categories of data and the pointers, the outcome scores, the pointers, the display criteria and the choice criteria.

2. A processor-based method for compiling and presenting a database of health care provider information, the method comprising the steps of:
compiling the health care provider information, where the health care provider information includes at least health care provider name information, health care provider location information, and health care provider service information, where the health care provider service information includes at least one of services performed as indicated by service code, service outcomes by service code, number of services performed by service code,
providing access to the database to health care providers that have associated health care provider information in the database,
providing health care provider-selectable user display criteria to the health care providers that have access to the database and recording in the database the user display criteria selected by the health care providers,
receiving from users health care provider selection criteria, where the health care provider selection criteria includes at least a subset of the health care provider information, and
presenting to the users additional portions of the health care provider information associated with the health care provider selection criteria, which matches the health care provider-selectable user display criteria, where services having related service codes are combined into a single display category.

3. The method of claim 2, wherein the health care provider location information includes at least address, city, state, and zip code.

4. The method of claim 2, wherein the health care provider-selectable user display criteria includes at least minimum number of services performed, maximum number of services performed, and minimum outcome for services performed.

5. The method of claim 2, wherein the additional portions of the health care provider information presented to the users is presented as summarized data within predetermined binned categories instead of actual data.

6. The method of claim 2, wherein information on health care providers other than those selected by the users is displayed for comparison purposes.

7. The method of claim 2, wherein the information displayed on the selected health care providers is sortable by user-selectable criteria, including at least number of combined services and outcomes of combined services.

8. The method of claim 2, wherein the outcomes rate is expressed as a percentage.

9. The method of claim 2, wherein the outcomes rate is expressed as a value in a binned category.

10. The method of claim 2, wherein the number of services is expressed as a number.

11. The method of claim 2, wherein the number of services is expressed as a value in a binned category.

12. A non-transitory computer-readable medium containing computer-readable instructions for instructing a computer to:
compile the health care provider information, where the health care provider information includes at least health care provider name information, health care provider location information, and health care provider service information, where the health care provider service information includes at least services performed as indicated by service code, service outcome by service code, and number of services performed by service code,
provide access to the database to health care providers that have associated health care provider information in the database,
provide health care provider-selectable user display criteria to the health care providers that have access to the database and recording in the database the user display criteria selected by the health care providers,
receive from users health care provider selection criteria, where the health care provider selection criteria includes at least a subset of the health care provider information, and
present to the users additional portions of the health care provider information associated with the health care provider selection criteria, which matches the health care provider-selectable user display criteria, where services having related service codes are combined into a single display category.

13. The computer-readable medium of claim 12, further comprising instructions for displaying advertisements for at least one of healthcare providers, related products, and related services.

14. The computer-readable medium of claim 12, further comprising instructions for obtaining the health care provider information directly from the health care providers.
